(19) United States
(12) Patent Application Publication
(10) Pub. No.: US 2017/0077785 A1
(43) Pub. Date: Mar. 16, 2017

(54) CONNECTING STRUCTURE OF DRIVING MOTOR AND REDUCER

(71) Applicant: Hyundai Motor Company, Seoul (KR)

(72) Inventors: Jungwoo Lee, Hwaseong (KR); Kyungseob Shin, Suwon (KR); Sangmo Ryu, Busan (KR); Dongyeon Han, Seoul (KR)

(21) Appl. No.: 14/962,071

(22) Filed: Dec. 8, 2015

(30) Foreign Application Priority Data
Sep. 10, 2015 (KR) 10-2015-0128553

(51) Int. Cl. H02K 7/116; H02K 5/10; H02K 5/04

(52) U.S. Cl. CPC H02K 7/116; H02K 5/04; H02K 5/10

(57) ABSTRACT

A connecting structure of a driving motor and a reducer includes the driving motor having a first shaft transmitting driving power to the reducer, a motor housing inside which the first shaft is mounted, and a first boss which is hollow and configured to protrude in a length direction of the first shaft at an end portion of the motor housing, and includes the reducer having a second shaft receiving the driving power by being connected with the first shaft, a reducer housing inside which the second shaft is mounted, and a second boss which is hollow and configured to protrude at an end portion of the reducer housing so as to be inserted into the first boss, and the first shaft and the second shaft pass through the first boss and the second boss respectively.

### CROSS-REFERENCE TO RELATED APPLICATION

The present application claims under 35 U.S.C. §119(a) the benefit of Korean Patent Application Number 10-2015-0128553 filed on Sep. 10, 2015, the entire contents of which are incorporated by reference herein.

### BACKGROUND

(a) Field of the Invention

The present invention relates to a connection structure of a driving motor and a reducer, and more particularly, to a connection structure of a driving motor and a reducer, which can maintain watertightness inside a driving motor without a watertight seal so as to reduce cost and improve fuel efficiency.

(b) Description of Related Art

Generally, a hybrid vehicle or an electric vehicle may generate a driving torque using an electric motor (hereinafter, referred to as a “driving motor”) which generates a torque with electric energy.

For example, the hybrid vehicle can be driven in an electric vehicle (EV) mode, which is a pure electric vehicle mode using only power of the driving motor, or in a hybrid electric vehicle (HEV) mode using both the torque of an engine and the driving motor as power.

In general, an electric vehicle is driven using the torque of the driving motor as a power source. The driving motor used as a power source may be connected with a reducer configured to reduce a rotation speed of the driving motor and amplify a torque of the driving motor based on a reduction gear ratio.

If water is introduced inside the driving motor, insulation may be impaired, and the driving motor may become inoperable, such that driving a vehicle may also become impossible.

In general, a watertight seal is mounted between a rotor shaft of the driving motor and a motor housing for water tightness of a driving motor.

FIG. 1 (PRIOR ART) illustrates a cross-sectional view and an enlarged view of a conventional connecting structure of a driving motor and a reducer.

Referring to FIG. 1, the conventional connection structure includes a watertight seal 5 which is mounted between a rotor shaft (or a first shaft) 10 and a motor housing 11 of a driving motor 100, the watertight seal 5 blocking inflow of water inside an inner space of the motor housing 11.

In addition, an oil seal 6 is mounted inside a reducer 200 between a reducer housing 21 and a reducer shaft (or a second shaft) 20, and the oil seal 6 blocks outflow of oil outside the reducer 200.

Watertight performance is secured by the watertight seal 5, but friction is generated at a contact portion between the watertight seal 5 and the rotor shaft 10 while the shaft 10 revolves, at least because the watertight seal 5 is disposed between the motor housing 11 and the shaft 10 which is a driving member.

Accordingly, fuel efficiency is deteriorated by friction loss.

Further, a problem may result from lack of durability of the watertight seal 5, and this can have a critical effect on operations of a vehicle.

In addition, a structure without the watertight seal 5 may be employed for increased fuel efficiency and improvement of watertightness durability, but an assembly process of a driving motor and a reducer may be complicated accordingly.

The above information disclosed in this Background section is only for enhancement of understanding of the background of the invention and therefore it may contain information that does not form the prior art that is already known in this country to a person of ordinary skill in the art.

### SUMMARY

Various aspects of the present invention are directed to providing a connecting structure of a driving motor and a reducer, in order to improve watertightness durability and fuel efficiency, reduce cost, and simplify an assembly process.

According to the present invention, a connecting structure of a driving motor and a reducer is provided, in which the driving motor preferably includes a first shaft transmitting driving power to the reducer, a motor housing inside which the first shaft is mounted, the motor housing defining an inside space thereof, and a first boss which is hollow and configured to protrude in a length direction of the first shaft at an end portion of the motor housing, the reducer preferably includes a second shaft receiving the driving power by being connected with the first shaft, a reducer housing inside which the second shaft is mounted, the reducer housing defining an inside space thereof, and a second boss which is hollow and configured to protrude at an end portion of the reducer housing so as to be inserted into the first boss, and the first shaft and the second shaft may pass through the first boss and the second boss respectively.

An O-ring may be mounted between the first boss and the second boss.

The connecting structure preferably does not include a watertight seal which is mounted between the first shaft and the motor housing, where such a watertight seal is typically arranged in a prior art structure to block inflow of water into the inner space of the motor housing.

The first boss and the second boss may have cylindrical shapes.

In other exemplary embodiments of the present invention, a connecting structure of a driving motor and a reducer is provided, in which the driving motor preferably includes a first shaft transmitting driving power to the reducer, a motor housing inside which the first shaft is mounted, the motor housing defining an inside space thereof, and a first boss which is hollow and configured to protrude in a length direction of the first shaft at an end portion of the motor housing, the reducer preferably includes a second shaft receiving the driving power by being connected with the first shaft, a reducer housing inside which the second shaft is mounted, the reducer housing defining an inside space thereof, and a second boss which is hollow and configured to protrude at an end portion of the reducer housing for the first boss to be inserted into the second boss, and the first shaft and the second shaft may pass through the first boss and the second boss respectively.

An O-ring may be mounted between the first boss and the second boss.

The connection structure preferably does not include a watertight seal which is mounted between the first shaft and the motor housing, where such a watertight seal is typically arranged in a prior art structure to block inflow of water into the inner space of the motor housing.

The second boss and the first boss may have cylindrical shapes.

In other exemplary embodiments of the present invention, a connecting structure of a driving motor and a reducer is provided, in which the driving motor preferably includes a first shaft transmitting driving power to the reducer, a motor housing inside which the first shaft is mounted, the motor housing defining an inside space thereof, and a first boss which is hollow and configured to protrude in a length direction of the first shaft at an end portion of the motor housing, the reducer preferably includes a second shaft receiving the driving power by being connected with the first shaft, a reducer housing inside which the second shaft is mounted, the reducer housing defining an inside space thereof, and a second boss which is hollow and configured to protrude at an end portion of the reducer housing to contact the first boss, and the first shaft and the second shaft may pass through the first boss and the second boss respectively.

An O-ring may be mounted between the first boss and the second boss.

The connection structure preferably does not include a watertight seal which is mounted between the first shaft and the motor housing, where such a watertight seal is typically arranged in a prior art structure to block inflow of water into the inner space of the motor housing.

The first boss and the second boss may have cylindrical shapes.

### BRIEF DESCRIPTION OF THE DRAWINGS

FIG. 1 (PRIOR ART) illustrates a cross-sectional view and an enlarged view of a prior connecting structure of a driving motor and a reducer.

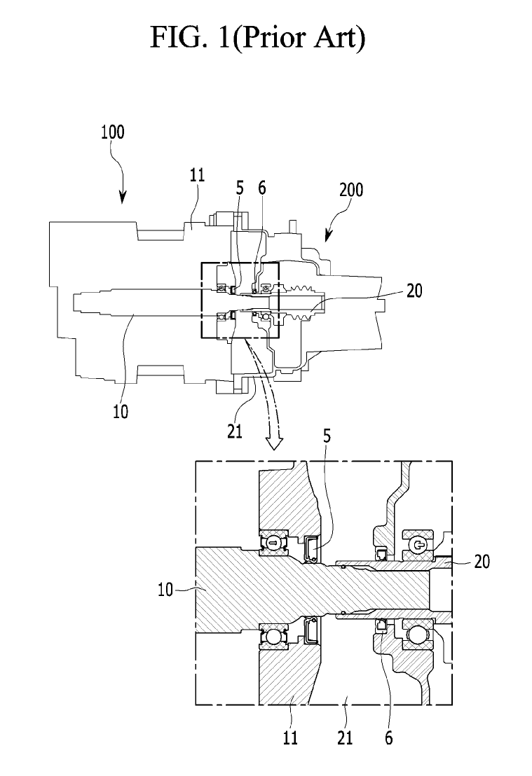

FIG. 2 illustrates a cross-sectional view and an enlarged view of a first exemplary embodiment of a connecting structure of a driving motor and a reducer according to the present invention.

FIG. 3 illustrates a cross-sectional view and an enlarged view of a second exemplary embodiment of a connecting structure of a driving motor and a reducer according to the present invention.

FIG. 4 illustrates a cross-sectional view and an enlarged view of a third exemplary embodiment of a connecting structure of a driving motor and a reducer according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

However, parts which are not related with the description are omitted for clearly describing the exemplary embodiments of the present invention and like reference numerals refer to like or similar elements throughout the specification.

In the following description, dividing names of components into first, second, and the like is to divide the names because the names of the components are the same as each other and an order thereof is not particularly limited.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

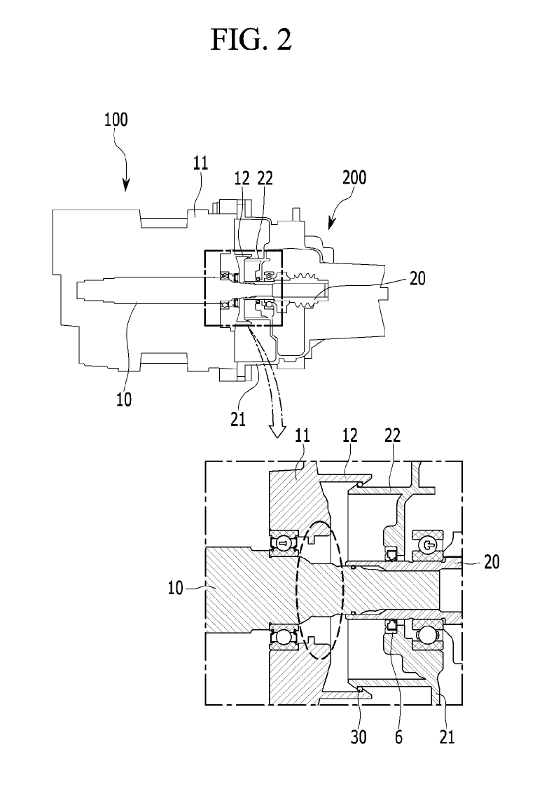

FIG. 2 illustrates a cross-sectional view and an enlarged view of a first exemplary embodiment of a connecting structure of a driving motor and a reducer according to the present invention.

Referring to FIG. 2, in the first exemplary embodiment of the connecting structure of a driving motor 100 and a reducer 200 according to the present invention, the driving motor 100 preferably includes a first shaft 10 transmitting driving power to the reducer 200, a motor housing 11 inside which the first shaft 10 is mounted, the motor housing 11 defining an inside space thereof (i.e., an inside space for receiving the first shaft 10), and a first boss 12 which is hollow and configured to protrude in a length direction of the first shaft 10 at an end portion of the motor housing 11, and the reducer 200 preferably includes a second shaft 20 receiving the driving power by being connected with the first shaft 10, a reducer housing 21 inside which the second shaft 20 is mounted, the reducer housing 21 defining an inside space thereof (i.e., an inside space for receiving the first shaft 10), and a second boss 22 which is hollow and configured to protrude at an end portion of the reducer housing 21 so as to be inserted into the first boss 10.

Further, the first shaft 10 and the second shaft 20 may be connected in a state of their passing through the first boss 12 and the second boss 22 respectively.

Through the configuration above, a conventional watertight seal 5 may be omitted as illustrated in a dotted line of the enlarged view of FIG. 2. In particular, the watertight seal 5 that is conventionally included in a connecting structure of the prior art is omitted in accordance with the present invention.

As a result, a durability problem of the watertight seal 5 can be avoided, and fuel consumption can be improved because friction loss on account of existence of a watertight seal 5 is substantially eliminated.

Further, an O-ring may be mounted between the first boss 12 and the second boss 22.

By means of the O-ring, watertightness inside the motor housing 11 is secured.

However, exemplary embodiments are not limited to watertightness by means of the O-ring 30, and any type of watertightness including watertightness by the second boss 22 being pressed into the first boss 12 is allowable as long as watertightness inside the motor housing 11 is secured.

In an aspect of durability, watertightness durability is improved because the O-ring 30 is not mounted at a rotating portion, but at a fixed portion.

In addition, the cost of the O-ring 30 amounts to only 50% of that of the watertight seal 5, and thus cost savings may be realized.

In an aspect of process, an O-ring 30 may be mounted to a second boss 22 before assembly of a driving motor 100 and a reducer 200, and afterwards, an assembly process is the same as in a prior method.

Therefore, an additional modularizing process is not generated.

The first exemplary embodiment is characterized in that the second boss 22 is inserted into the first boss 12.

That is, the first boss 12 is a female boss and the second boss 22 is a male boss.

The first boss 12 and the second boss 22 may have cylindrical shapes, but exemplary embodiments are not limited to the cylindrical shapes.

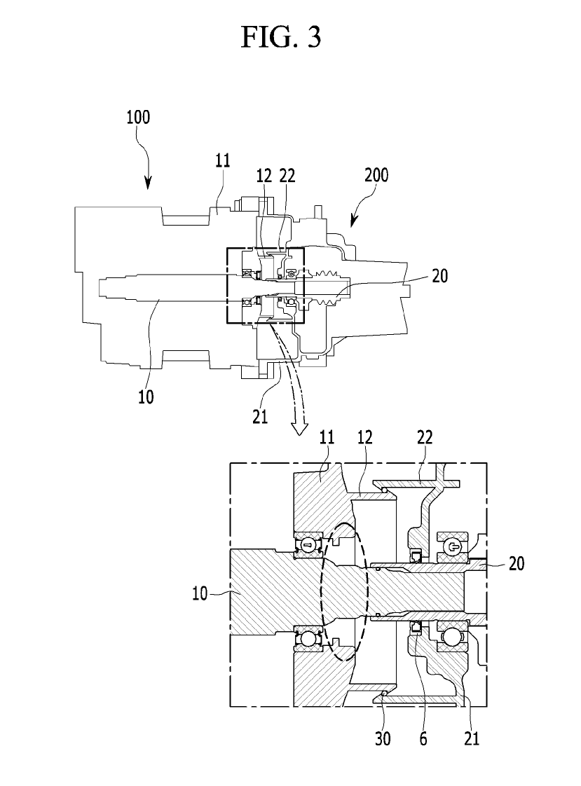

FIG. 3 illustrates a cross-sectional view and an enlarged view of a second exemplary embodiment of a connecting structure of a driving motor and a reducer according to the present invention.

Referring to FIG. 3, in the second exemplary embodiment of the connecting structure of a driving motor 100 and a reducer 200 according to the present invention, the driving motor 100 preferably includes a first shaft 10 transmitting driving power to the reducer 200, a motor housing 11 inside which the first shaft 10 is mounted, the motor housing 11 defining an inside space thereof, and a first boss 12 which is hollow and configured to protrude in a length direction of the first shaft 10 at an end portion of the motor housing 11, and the reducer 200 preferably includes a second shaft 20 receiving the driving power by being connected with the first shaft 10, a reducer housing 21 inside which the second shaft 20 is mounted, the reducer housing 21 defining an inside space thereof, and a second boss 22 which is hollow and configured to protrude at an end portion of the reducer housing 21 for the first boss 10 to be inserted into the second boss 22.

Further, the first shaft 10 and the second shaft 20 may be connected in a state of their passing through the first boss 12 and the second boss 22 respectively.

Also in the second exemplary embodiment of FIG. 3, a conventional watertight seal 5 may be omitted as illustrated in a dotted line of the enlarged view.

As a result, a durability problem of the watertight seal 5 can be avoided, and fuel efficiency is improved because friction loss on account of existence of the watertight seal 5 is substantially eliminated.

Further, an O-ring may be mounted between the first boss 12 and the second boss 22.

By means of the O-ring, watertightness inside the motor housing 11 is secured.

However, exemplary embodiments are not limited to watertightness by means of the O-ring 30, and any type of watertightness including watertightness by the first boss 12 being pressed into the second boss 22 is allowable as long as watertightness inside the motor housing 11 is secured.

In aspects of durability and cost, an effect of the second exemplary embodiment is the same as that of the first exemplary embodiment.

In an aspect of process, an O-ring 30 may be mounted to a first boss 12 before assembly of a driving motor 100 and a reducer 200, and afterwards, an assembly process is the same as in a conventional method.

Therefore, an additional modularizing process is not generated.

The second exemplary embodiment is characterized in that the first boss 12 is inserted into the second boss 22.

That is, the first boss 12 is a male boss and the second boss 22 is a female boss.

The first boss 12 and the second boss 22 may have cylindrical shapes, but exemplary embodiments are not limited to the cylindrical shapes.

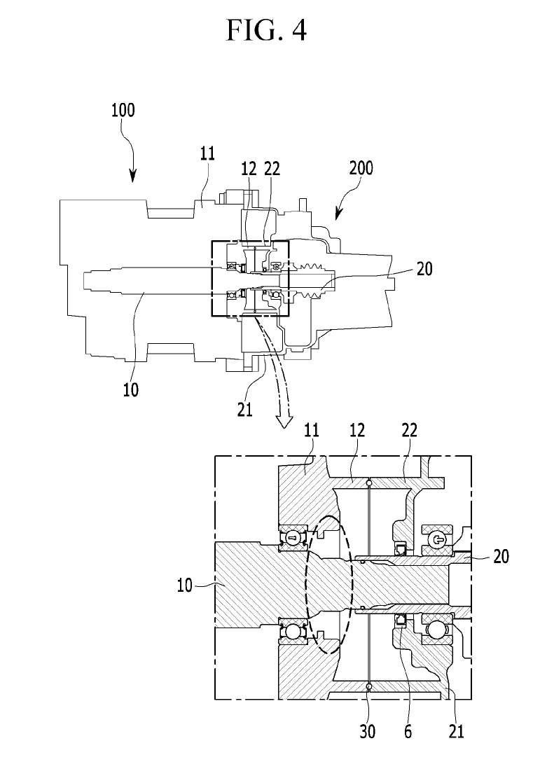

FIG. 4 illustrates a cross-sectional view and an enlarged view of a third exemplary embodiment of a connecting structure of a driving motor and a reducer according to the present invention.

Referring to FIG. 4, in the third exemplary embodiment of the connecting structure of a driving motor 100 and a reducer 200 according to the present invention, the driving motor 100 preferably includes a first shaft 10 transmitting driving power to the reducer 200, a motor housing 11 inside which the first shaft 10 is mounted, the motor housing 11 defining an inside space thereof, and a first boss 12 which is hollow and configured to protrude in a length direction of the first shaft 10 at an end portion of the motor housing 11, and the reducer 200 preferably includes a second shaft 20 receiving the driving power by being connected with the first shaft 10, a reducer housing 21 inside which the second shaft 20 is mounted, the reducer housing 21 defining an inside space thereof, and a second boss 22 which is hollow and configured to protrude at an end portion of the reducer housing 21 to contact the first boss 12.

Further, the first shaft 10 and the second shaft 20 may be connected in a state of their passing through the first boss 12 and the second boss 22 respectively.

Also in the third exemplary embodiment of FIG. 4, a conventional watertight seal 5 may be omitted as illustrated in a dotted line of the enlarged view.

As a result, a durability problem of the watertight seal 5 can be avoided, and fuel consumption is improved because friction loss on account of existence of a watertight seal 5 is substantially eliminated.

Further, an O-ring may be mounted between the first boss 12 and the second boss 22.

In this case, the O-ring 30 is mounted between contacting surfaces of the first boss 12 and the second boss 22.

By means of the O-ring, watertightness inside the motor housing 11 is secured.

However, exemplary embodiments are not limited to watertightness by means of the O-ring 30, and any type of watertightness including watertightness by the first boss 12 and the second boss 22 being bonded is allowable as long as watertightness inside the motor housing 11 is secured.

In aspects of durability, cost, and process, an effect of the third exemplary embodiment is the same as those of the first exemplary embodiment and the second exemplary embodiment.

The third exemplary embodiment is characterized in that the first boss 12 and the second boss 22 contact each other.

That is, contacting surfaces of the first boss 12 and the second boss 22 may have identical shapes.

The first boss 12 and the second boss 22 may have cylindrical shapes, but exemplary embodiments are not limited to the cylindrical shapes.

As explained in detail, watertightness durability and fuel efficiency are improved, cost is reduced, and an assembly process of a driving motor and a reducer can be simplified according to the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A connecting structure of a driving motor and a reducer, comprising:
the driving motor comprising:
a first shaft transmitting driving power to the reducer;
a motor housing inside which the first shaft is mounted, the motor housing defining an inside space for receiving the first shaft; and
a first boss which is hollow and configured to protrude in a length direction of the first shaft at an end portion of the motor housing; and
the reducer comprising:
a second shaft receiving the driving power by being connected with the first shaft;
a reducer housing inside which the second shaft is mounted, the reducer housing defining an inside space of the second shaft; and
a second boss which is hollow and configured to protrude at an end portion of the reducer housing so as to be inserted into the first boss,
wherein the first shaft and the second shaft pass through the first boss and the second boss respectively.

2. The connecting structure of claim 1, wherein:
an O-ring is mounted between the first boss and the second boss.

3. The connecting structure of claim 1, in which a watertight seal is omitted between the first shaft and the motor housing.

4. The connecting structure of claim 1, wherein:
the first boss and the second boss have cylindrical shapes.

5. A connecting structure of a driving motor and a reducer, comprising: the driving motor comprising:
a first shaft transmitting driving power to the reducer;
a motor housing inside which the first shaft is mounted, the motor housing defining an inside space for receiving the first shaft; and
a first boss which is hollow and configured to protrude in a length direction of the first shaft at an end portion of the motor housing; and
the reducer comprising:
a second shaft receiving the driving power by being connected with the first shaft;
a reducer housing inside which the second shaft is mounted, the reducer housing defining an inside space of the second shaft; and
a second boss which is hollow and configured to protrude at an end portion of the reducer housing for the first boss to be inserted into the second boss,
wherein the first shaft and the second shaft pass through the first boss and the second boss respectively.

6. The connecting structure of claim 5, wherein:
an O-ring is mounted between the first boss and the second boss.

7. The connecting structure of claim 5, in which a watertight seal is omitted between the first shaft and the motor housing.

8. The connecting structure of claim 5, wherein:
the first boss and the second boss have cylindrical shapes.

9. A connecting structure of a driving motor and a reducer, comprising:
the driving motor comprising:
a first shaft transmitting driving power to the reducer;
a motor housing inside which the first shaft is mounted, the motor housing defining an inside space for receiving the first shaft; and
a first boss which is hollow and configured to protrude in a length direction of the first shaft at an end portion of the motor housing; and
the reducer comprising:
a second shaft receiving the driving power by being connected with the first shaft;
a reducer housing inside which the second shaft is mounted, the reducer housing defining an inside space of the second shaft; and
a second boss which is hollow and configured to protrude at an end portion of the reducer housing to contact the first boss,
wherein the first shaft and the second shaft pass through the first boss and the second boss respectively.

10. The connecting structure of claim 9, wherein:
an O-ring is mounted between the first boss and the second boss.

11. The connecting structure of claim 9, in which a watertight seal is omitted between the first shaft and the motor housing.

12. The connecting structure of claim 9, wherein:
the first boss and the second boss have cylindrical shapes.
